(19) United States
(12) Patent Application Publication
(10) Pub. No.: US 2009/0239024 A1
(43) Pub. Date: Sep. 24, 2009

(54) Channel fleece and method for making same

(76) Inventor: Raymond Yu, Taipei (TW)

Correspondence Address: CHARLES J RUPNICK, PO BOX 46752, SEATTLE, WA, 98146, US

(21) Appl. No.: 12/381,675

(22) Filed: Mar. 13, 2009

Related U.S. Application Data
(60) Provisional application No. 61/069,342, filed on Mar. 14, 2008.

(51) Int. Cl. D03D 27/12; B32B 33/00; D03D 27/00

(52) U.S. Cl. 428/88; 428/90; 139/2; 139/399

(57) ABSTRACT

A novel lofted fiber or pile-type of fabric such as fleece, and an improved method of weaving the same. The improved lofted fiber or pile-type of fabric includes an underlying fabric substrate, a plurality of lofted fibers coupled into one portion of the underlying fabric substrate, and a different portion of the underlying fabric substrate adjacent to the portion having the plurality of lofted fibers that is substantially devoid of all lofted fibers.

This application claims the benefit of U.S. Provisional Application Ser. No. 61/069,342, filed in the name of the same inventor Raymond Yu on Mar. 14, 2008, the complete disclosure of which is incorporated herein by reference.

### FIELD OF THE INVENTION

The present invention relates generally to lofted fiber or pile-type of fabrics such as fleeces, and in particular to means for providing a bonding edge for a waterproof seam seal, such fabrics being provided with such bonding edge for a waterproof seam seal, and garments fabricated of such fabrics joined with one or more such waterproof seam seals of a type formed utilizing such a bonding edge.

### BACKGROUND OF THE INVENTION

Water resistant seams are known for use with lofted fiber types or pile-type of fabrics such as fleeces, which is a soft napped insulating synthetic wool fabric made from PET (polyethylene terephthalate) or another synthetic fiber and found under such brand names as Polarfleece®, Polartec® and others of the same category.

However, known water resistant seams between joined portions of such fabrics are not effectively waterproof as is desirable in garments, such as waders, that are immersed in water during use. The fabrication methods known for forming such water resistant seams in such fabrics are thus limited in their ability to provide efficient and reliable water resistance in immersion situations.

### SUMMARY OF THE INVENTION

The present invention is an improved lofted fiber or pile-type of fabric such as fleece, and an improved method of weaving the same. The improved lofted fiber or pile-type of fabric includes an underlying fabric substrate, a plurality of lofted fibers coupled into one portion of the underlying fabric substrate, and a different portion of the underlying fabric substrate adjacent to the portion having the plurality of lofted fibers that is substantially devoid of all lofted fibers.

According to another aspect of the invention, the portion of the underlying fabric substrate having the plurality of lofted fibers further defines a lofted portion of a garment pattern piece of the improved lofted fiber or pile-type of fabric, and the portion of the underlying fabric substrate that is substantially devoid of lofted fibers further defines one or more peripheral edges the garment pattern piece.

According to another aspect of the invention, the portion of the underlying fabric substrate that is substantially devoid of lofted fibers further defines a channel portion of the underlying fabric substrate positioned between the lofted portion of the underlying fabric substrate having the plurality of lofted fibers and a different portion of the underlying fabric substrate having a different plurality of lofted fibers coupled thereinto.

According to another aspect of the invention, the channel portion of the underlying fabric substrate is a substantially continuous channel that is substantially devoid of lofted fibers along a substantially entire continuous length thereof.

According to another aspect of the invention, each of the different portions of the underlying fabric substrate having a plurality of lofted fibers further defines a lofted portion of one of a plurality of different garment pattern pieces, and the channel portion of the underlying fabric substrate further defines one or more peripheral edges of one or more of the plurality of garment pattern pieces.

According to another aspect of the invention, the improved lofted fiber or pile-type of fabric also includes one or more cuts that are formed in the underlying fabric substrate along the channel portion thereof. Also, according to another aspect of the invention, the one or more cuts formed in the underlying fabric substrate further defines one of the plurality of garment pattern pieces.

According to another aspect of the invention, the underlying fabric substrate is a woven fabric substrate, and the plurality of lofted fibers are either woven or machined into the underlying fabric substrate in a pattern defining a lofted portion of a garment piece.

According to another aspect of the invention, a method of manufacturing a lofted fiber fabric is provided, the method including: in an underlying fabric substrate, substantially filling a lofted portion thereof with a plurality of lofted fibers. Then, again in the underlying fabric substrate, providing a fiber-free portion of the underlying fabric substrate that is substantially devoid of the lofted fibers; and positioning the fiber-free portion of the underlying fabric substrate adjacent to the lofted portion thereof.

According to another aspect of the method of the invention, the step of substantially filling a lofted portion of the underlying fabric substrate with a plurality of lofted fibers is accomplished by either weaving or machining the underlying fabric substrate with a plurality of the lofted fibers in a pattern defining a lofted portion of a garment piece. Furthermore, the step of providing a fiber-free portion of the underlying fabric substrate that is substantially devoid of lofted fibers is accomplished by providing a substantially continuous fiber-free portion of the underlying fabric substrate substantially surrounding the lofted portion of the garment piece.

According to another aspect of the method of the invention, the step of providing a substantially continuous fiber-free portion of the underlying fabric substrate is further accomplished by providing a substantially continuous fiber-free channel portion of the underlying fabric substrate.

According to another aspect of the method of the invention, the method further includes: on a computerized machine for coupling the plurality of lofted fibers to the underlying fabric substrate, operating a software program for accomplishing all of: the substantially filling a lofted portion of the underlying fabric substrate with a plurality of lofted fibers, the providing a substantially continuous fiber-free portion of the underlying fabric substrate substantially surrounding the lofted portion, and the positioning the fiber-free portion of the underlying fabric substrate adjacent to the lofted portion thereof.

According to another aspect of the method of the invention, the step of operating a software program on a computerized machine for coupling the plurality of lofted fibers to the underlying fabric substrate is further defined by operating the software program on a computerized jacquard terry loop machine.

According to another aspect of the method of the invention, the method further includes forming one or more cuts in the underlying fabric substrate along the fiber-free portion thereof spaced away from and substantially surrounding the lofted portion of the garment piece, and separating the garment piece from the underlying fabric substrate.

The improved method includes knitting a pattern into a fleece or lofted fabric using computerized knitting equipment. The knitting equipment is programmed to systematically omit fibers in predetermined channels to produce patterns in rolled fleece fabrics.

According to another aspect of the invention, the present invention is a fleece or lofted fabric resulting from practice of the method of the invention whereby the fabric includes these patterns of “open” channels in the underlying substrate or panel that are devoid of the lofted fibers, which provides a channel free of lofted fibers. The patterns of “open” or fiber-free channels are optionally either substantially continuous around an entire peripheral edge of a garment pattern piece, or discontinuous. The underlying substrate of the fabric in the fiber-free channels provides a bonding surface that is better for the application of glue and tape to the fabric than the substrate having the lofted fibers.

According to another aspect of the invention, the fiber-free channels are additionally useful for cutting from the woven flat sheet or panel of fleece or lofted fabric garment pattern pieces having fiber-free edges by cutting the underlying substrate of the fabric in the fiber-free channels. According to one aspect of the invention, when adjacent garment pattern pieces share a common boundary, the garment pattern pieces are formed by cutting the underlying substrate of the fabric substantially along centerlines of the fiber-free channels, whereby each of the adjacent pattern pieces includes a portion of a shared fiber-free channel along an edge thereof.

According to another aspect of the invention, the present invention is an improved fleece or lofted fabric having fiber-free channels formed along one or more peripheral edges of one or more garment pattern pieces, wherein the fiber-free channels are devoid of lofted fibers common to a remainder of the fabric forming the pattern piece. According to one aspect of the invention, the peripheral edges of the garment pattern piece wherein the fiber-free channels are devoid of lofted fibers are optionally either substantially continuous around the entire garment pattern piece, or discontinuous.

According to another aspect of the invention, two or more of the garment pattern pieces each having one of the fiber-free channels devoid of lofted fibers formed along a mating edge are subsequently joined into a garment or another product by forming one or more seams in the corresponding fiber-free channels forming the mating edges. A waterproof glue and/or tape is permanently applied to the seam. Forming the one or more seams in the corresponding fiber-free channels permits effective permanent application of the glue and/or tape to the seams. According to another aspect of the invention, one or more of the seams joining the mating garment pattern pieces is formed by such gluing or taping using known waterproof products. Such gluing and taping is beneficial in joining and/or sealing seams created when two or more pieces of fabric are joined together. This methodology is particularly useful in sealing seams of waterproof fabrics.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the product and process of the invention using an illustration of an improved fleece or lofted fabric having substantially continuous fiber-free pathways or channels formed along one or more peripheral edges of one or more garment pattern pieces;

FIG. 2 is a cross-sectional side view of the improved fleece or lofted fabric according to the invention having substantially continuous fiber-free pathways or channels formed along one or more peripheral edges of one or more garment pattern pieces as illustrated in FIG. 1; and

FIG. 3 illustrates one exemplary software program that eliminates the lofted fibers or loops in specific areas of the fleece or lofted fabric panel according to the present invention as illustrated in FIGS. 1 and 2.

### DETAILED DESCRIPTION OF PREFERRED EMBODIMENT

In the Figures, like numerals indicate like elements.

The general purpose of the present invention is to provide an impenetrable, waterproof seam seal or bonding edge to lofted fiber types or pile-type of fabrics such as fleeces found under such brand names as Polar Fleece and others of that category.

The present invention is optionally utilized on the following types of finished products for joining purposes and/or to make them waterproof: jackets, pants, fishing waders, hunting waders, including waterfowl waders, vests, bibs, coveralls, etc. for boys, girls, men and women.

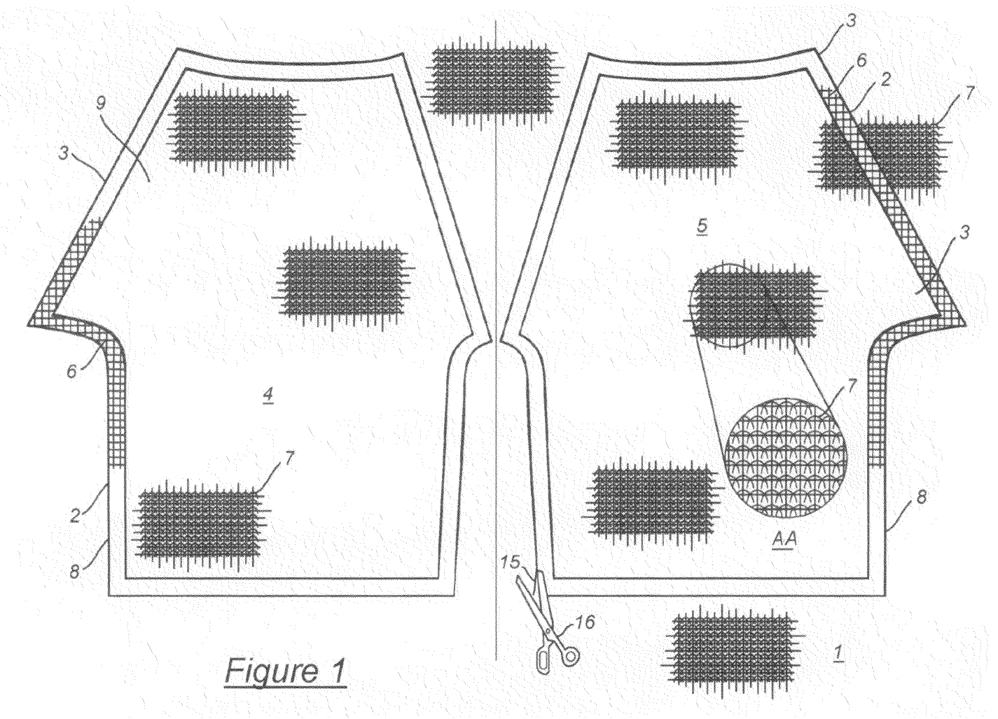

FIG. 1 illustrates the process of the invention using an illustration of an improved fleece or lofted fabric 1 having substantially continuous fiber-free pathways or channels 2 formed along one or more peripheral edges 3 of one or more garment pattern pieces 4 and 5. As illustrated, the an underlying fabric substrate or panel 6 is formed with the fiber-free channels 2 being devoid of lofted fibers 7 (inset AA) common to a remaining body of the fabric 1 forming the lofted pattern pieces 4, 5. Fleece and/or lofted fabric is knitted in such a way that channels 2 of lofted fibers 7 are systematically omitted to produce one or more patterns 8 in rolled fleece fabrics 1 defining the pattern pieces 4, 5, while a central lofted portion 9 of the underlying fabric substrate 6 is woven or otherwise machined with a plurality of the lofted fibers 7.

The channels 2 surrounding the lofted portions 9 are left open in the lofted fabrics 1 between the lofted portions 9 of the pattern pieces 4, 5 in order to eliminate the lofted fibers 7 from the underlying substrate or panel 6 in order to provide one or more fiber-free channels 2. These channels 2 provide a better bonding surface for the application of glue and tape to the fleece fabric 1. These channels 2 are useful for cutting the lofted garment pattern pieces 4, 5 with the fiber-free edges 3 that can subsequently be joined into garments/products and allow effective permanent application of glue and/or tape to the seams. Such gluing and taping is beneficial in joining and/or sealing seams created when two or more pieces of fabric are joined together. This methodology is particularly useful in sealing seams of waterproof fabrics.

This process for weaving fabrics with this channel 2 is accomplished on weaving machines for producing any fleece or lofted fabric 1, such machines includes a computerized jacquard terry loop machine as seen with such brands as Fukuhara (Japanese), Mayer (German) and Bie Luon (Taiwanese) as well as any other types similar in creating fabrics having a ‘pile’ or ‘loop’ effect. Fabrics 1 can be of any content such as polyester, nylon, and others.

These machines produce the flat fabric panel 1 having the underlying substrate or panel 6 with loops or lofted fibers 7 on one side, which creates a loft or pile effect, in essence making a fabric with a pile height consisting of individual loops or lofted fibers 7. The process involves inputting into these computer driven machines a pattern or design needed to produce the patterned lofted garment pieces 4, 5 for joining together to make the finished product, including creating a software program specific to the machine for arranging a size of knitting to knit different sizes of the pattern or design on a size-by size basis so that each of the patterned lofted garment pieces 4, 5 includes both the lofted portion 9 and at least a portion of the channels 2. The process of the invention also involves creating a software program that weaves or machines the lofted fibers or loops 7 into the underlying substrate 6 in specific areas of the fabric panel 1 defining one or more of the lofted portions 9, while leaving specific areas of the underlying substrate 6 adjacent to the lofted portions 9 substantially devoid of any lofted fibers 7. The process of the invention thereby creates the channels 2 of specific widths and lengths along one or more of the peripheral edges 3 being devoid of the lofted fibers or loops 7 common to the remaining body of the fabric 1 for forming the lofted portions 9 of the pattern pieces 4, 5 in order to enable bonding a seam with conventional sealing tape using tape and glue.

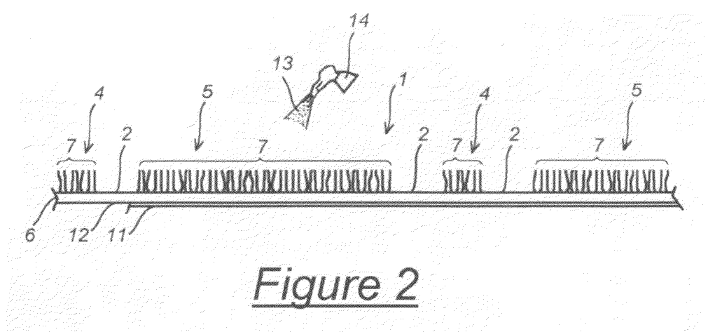

FIG. 2 is a cross-sectional side view of the improved fleece or lofted fabric panel 1 having several of the lofted garment pattern pieces 4, 5 wherein the underlying substrate 6 is knitted with the lofted fibers 7 in the lofted portions 9. The fabric panel 1 also includes a plurality of the substantially continuous fiber-free pathways or channels 2 formed along one or more peripheral edges 3 of one or more of the lofted garment pattern pieces 4, 5.

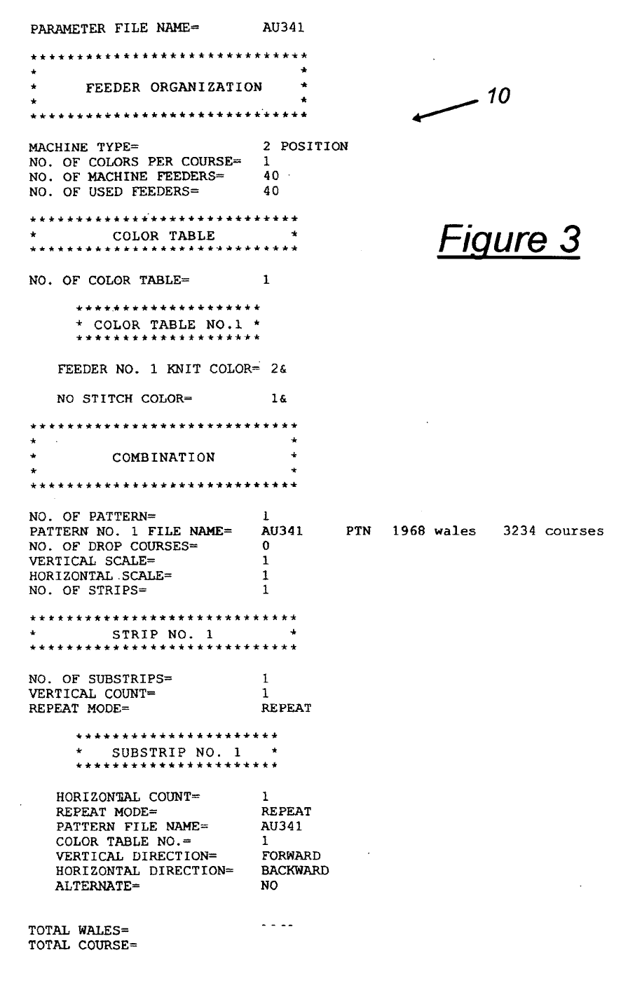

FIG. 3 illustrates one such software program 10 that couples a plurality of the lofted fibers or loops 7 in a pattern substantially filling the lofted portions 9 of the fabric panel 1, while the same software program 10 eliminates the lofted fibers or loops 7 in specific areas of the fabric panel 1 according to the present invention. Here, once the fabric panel 1 is manufactured it is woven or machined with these patterns of the pattern pieces 4, 5 and having one or more lofted portions 9 substantially surrounded by one or more specific peripheral flat and fabric-free channels 2. The software program illustrated here is operable on one of the weaving machines for producing any fleece or lofted fabric 1, such as the computerized jacquard terry loop machine discussed herein, as well as any other types similar in creating fabrics having a ‘pile’ or ‘loop’ effect.

Optionally, as illustrated in FIGS. 1 and 2, the fabric-free channels 2 are formed with a substantially continuous width. After the lofted fibers 7 are woven into the underlying substrate 6 in the specific lofted portions 9 of the garment pattern pieces 4, 5, the fabric panel 1 is then optionally processed further, though not necessary, by applying a film 11 to an underside 12 in what is commonly referred to as “lamination,” which is the process of bonding a film such as a polypropylene or other similar films as waterproof or breathable films using a permanent adhesion agent such as glue. Another fabric is optionally ‘laminated’ to the other side of the film as well, though not necessary.

Optionally, a durable water repellant (DRW) agent 13 can be applied to the fabric 1 or fabrics 1 at any point in the process as well. For example, the DRW agent 13 is applied to the fabric 1 by spraying utilizing conventional spraying equipment 14.

As illustrated in FIG. 1, one or more cuts 15 are then made, as by any suitable conventional cutting equipment 16, in the channels 2 of the finished laminated fabric panel 1 thereby making the one or more final peripheral pattern edges 3 flat and free of the lofted fibers or loops 7 for the effective application of seam tape and a permanent bond to the fabrics. In a waterproof type application, this tape provides a waterproof seal to the interior film creating a waterproof seam that remains watertight even when fully immersed in water during use.

While the preferred and additional alternative embodiments of the invention have been illustrated and described, it will be appreciated that various changes can be made therein without departing from the spirit and scope of the invention.

What is claimed is:

1: A lofted fiber fabric, comprising:
an underlying fabric substrate;
a plurality of lofted fibers coupled into one portion of the underlying fabric substrate; and
a different portion of the underlying fabric substrate adjacent to the portion having the plurality of lofted fibers being substantially devoid of lofted fibers.

2: The lofted fiber fabric of claim 1 wherein the portion of the underlying fabric substrate having the plurality of lofted fibers further defines a lofted portion of a garment pattern piece; and
wherein the portion of the underlying fabric substrate substantially devoid of lofted fibers further defines one or more peripheral edges the garment pattern piece.

3: The lofted fiber fabric of claim 2 wherein the portion of the underlying fabric substrate substantially devoid of lofted fibers further comprises a channel portion of the underlying fabric substrate positioned between the lofted portion of the underlying fabric substrate having the plurality of lofted fibers and a different portion of the underlying fabric substrate having a different plurality of lofted fibers coupled thereinto.

4: The lofted fiber fabric of claim 3 wherein the channel portion of the underlying fabric substrate further comprises a substantially continuous channel being substantially devoid of lofted fibers along a substantially entire continuous length thereof.

5: The lofted fiber fabric of claim 4 wherein each of the portions of the underlying fabric substrate having a plurality of lofted fibers further defines a lofted portion of one of a plurality of different garment pattern pieces; and
wherein the channel portion of the underlying fabric substrate further defines one or more peripheral edges of one or more of the plurality of garment pattern pieces.

6: The lofted fiber fabric of claim 5, further comprising one or more cuts formed in the underlying fabric substrate along the channel portion thereof.

7: The lofted fiber fabric of claim 6 wherein the one or more cuts formed in the underlying fabric substrate further defines one of the plurality of garment pattern pieces.

8: The lofted fiber fabric of claim 7 wherein the underlying fabric substrate further comprises a woven fabric substrate.

9: A lofted fiber fabric, comprising:
an underlying woven fabric substrate;
a lofted portion of the underlying fabric substrate comprising a plurality of lofted fibers knitted thereinto; and
a fiber-free portion formed of the underlying fabric substrate being substantially devoid of lofted fibers, the fiber-free portion of the underlying fabric substrate being positioned adjacent to the lofted portion thereof.

10: The lofted fiber fabric of claim 9, further comprising a plurality of different lofted portions of the underlying fabric substrate each comprising a different plurality of the lofted fibers knitted thereinto; and
wherein the fiber-free portion of the underlying fabric substrate further comprises a substantially continuous channel portion positioned between two or more of the plurality of different lofted portions of the underlying fabric substrate and spacing apart the two or more different lofted portions, the substantially continuous channel being substantially devoid of lofted fibers along a substantially entire continuous length thereof.

11: The lofted fiber fabric of claim 10 wherein the channel portion of the underlying fabric substrate further comprises a substantially continuous width.

12: The lofted fiber fabric of claim 10 wherein one or more of the channel portions of the underlying fabric substrate further define one or more peripheral edges a plurality of different garment pattern pieces.

13: The lofted fiber fabric of claim 12, further comprising one or more cuts formed in the underlying fabric substrate along the channel portion thereof.

14: The lofted fiber fabric of claim 13 wherein the one or more cuts formed in the underlying fabric substrate further define one or more of the plurality of garment pattern pieces separate from the underlying fabric substrate.

15: A method of manufacturing a lofted fiber fabric, the method comprising:
in an underlying fabric substrate, substantially filling a lofted portion thereof with a plurality of lofted fibers;
in the underlying fabric substrate, providing a fiber-free portion of the underlying fabric substrate that is substantially devoid of the lofted fibers; and
positioning the fiber-free portion of the underlying fabric substrate adjacent to the lofted portion thereof.

16: The method of claim 15 wherein the substantially filling a lofted portion of the underlying fabric substrate with a plurality of lofted fibers further comprises one of weaving or machining the underlying fabric substrate with a plurality of the lofted fibers in a pattern defining a lofted portion of a garment piece; and
wherein the providing a fiber-free portion of the underlying fabric substrate that is substantially devoid of lofted fibers further comprises providing a substantially continuous fiber-free portion of the underlying fabric substrate substantially surrounding the lofted portion of the garment piece.

17: The method of claim 16 wherein the providing a substantially continuous fiber-free portion of the underlying fabric substrate further comprises providing a substantially continuous fiber-free channel portion of the underlying fabric substrate.

18: The method of claim 16 further comprising: on a computerized machine for coupling the plurality of lofted fibers to the underlying fabric substrate, operating a software program for accomplishing all of: the substantially filling a lofted portion of the underlying fabric substrate with a plurality of lofted fibers, the providing a substantially continuous fiber-free portion of the underlying fabric substrate substantially surrounding the lofted portion, and the positioning the fiber-free portion of the underlying fabric substrate adjacent to the lofted portion thereof.

19: The method of claim 18 wherein the operating a software program on a computerized machine for coupling the plurality of lofted fibers to the underlying fabric substrate further comprises operating the software program on a computerized jacquard terry loop machine.

20: The method of claim 18, further comprising forming one or more cuts in the underlying fabric substrate along the fiber-free portion thereof spaced away from and substantially surrounding the lofted portion of the garment piece, and separating the garment piece from the underlying fabric substrate.
